(19) United States
(12) Patent Application Publication
(10) Pub. No.: US 2016/0337371 A1
(43) Pub. Date: Nov. 17, 2016

(54) APPARATUS AND METHODS FOR ADMINISTERING ONLNE CONTENT ACCESED BY A MINOR

(71) Applicant: Yearbooker, Inc., New York, NY (US)

(72) Inventors: Fanny Chung Davidson, New York, NY (US); Robert Davidson, New York, NY (US)

(21) Appl. No.: 15/099,841

(22) Filed: Apr. 15, 2016

Related U.S. Application Data
(60) Provisional application No. 62/148,712, filed on Apr. 16, 2015.

(51) Int. Cl. H04L 29/06; H04W 12/08

(52) U.S. Cl. CPC H04L 63/102; H04W 12/08; H04L 63/308

(57) ABSTRACT

The present disclosure relates to apparatus and methods that allow a Parent or other designated guardian to screen, intercept and monitor messages sent to and sent from a child thereby allowing the parent to filter and approve communications involving a minor. Implementations may include a downloadable or pre-installed app, an API or other executable code.

### CROSS REFERENCE TO RELATED APPLICATIONS

The present disclosure claims the benefit to Provisional Patent Application Ser. No. 62/148,712, filed Apr. 16, 2015 and entitled “Apparatus and Methods for Administering Online Content Accessed by a Minor”, the content of which are incorporated herein by reference.

### FIELD OF THE DISCLOSURE

The present disclosure relates to methods and that allow a Parent or other designated guardian to control content of message received by a Child before the Child sees it, and monitor messages sent to and sent from a child after they've been sent and/or read, thereby allowing the parent to filter and approve communications involving a minor.

### BACKGROUND OF THE DISCLOSURE

Traditionally, children (less than 13 years old) or legal minors (less than 18 years old) access distributed networks, such as the Internet, to communicate with other children or minors or adults in an unmitigated fashion. Once a parent provides authorization for a child to have access to a site, or to engage in game playing the Parent does not have a method or apparatus to effectively monitor or control what a child is exposed to.

Online interactions may provide benefits for a child, but also may expose the child to bullying, predatory actions, or content the Parent simply finds inappropriate or offensive.

### SUMMARY OF THE DISCLOSURE

Accordingly, the present invention provides apparatus and methods for screening, tracking and controlling electronic communications to and from a child and/or minor. In some embodiments, disparate network access devices are operated by Parent and Child. An adult is registered as the Parent of the Child and kept apprised of communications sent to and from the Child. In some embodiments, a person acting as Parent is certified as an adult via an identification mechanism, such as, for example a driver's license number, credit card or a social security number. The Parent is provided functionality to block a message, block a sender/receiver, monitor communications, track a history of communications, track a number of communications, track a duration of communications, and limit an amount of time a Child engages in a specified activity or in communication with a specified communicant.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a functional diagram of a prior art system.

FIG. 2 illustrates a functional chart with an exemplary data flow and decision-making chart.

FIG. 3A illustrates exemplary implementations of the present invention involving In-App messaging and Parent Approval.

FIG. 3B illustrates exemplary implementations of the present invention involving a first user sending a message to a second user and the message being blocked.

FIG. 4 illustrates aspects of controller hardware useful for implementing the present invention as a block diagram.

FIG. 5 illustrates an exemplary processing and interface system.

FIG. 6 illustrates a block diagram of an exemplary embodiment of a mobile device.

FIG. 7 illustrates a graphical user interface that may be utilized in some embodiments of a ParentScreen device. Replace with new diagrams

### DETAILED DESCRIPTION

The present invention provides apparatus and methods that allow a Parent or other designated guardian to screen, intercept and monitor messages sent to and sent from a child thereby allowing the parent to filter and approve communications involving a minor. Implementations may include a communications network access device controlled by one or more of: a downloadable app, an API or other executable code.

As used herein a Parent shall mean an adult associated with at least one of: a Child and a Minor. In some embodiments, a Parent will be certified as an adult.

As used herein a Child shall mean a person 13 years of age or younger who is associated with a Parent.

As used herein a Minor shall mean a person between the ages of 14 and 18 years old who is associated with a Parent.

Ordinarily, games and chat programs send a standardized or proprietary format message from peer device to peer device. Frequently these are used by under 13 year olds and the apps are not complaint with the Federal Trade Commission's COPPA rule. By publishing a standard ParentScreen message exchange format, the message can be held in a queue by the originating service until acted upon by a parent or guardian, providing COPPA compliance. The app message can be flagged to mask/hide or allow message pass through based on parent approval. Messages may include one or more of: text strings, emoticons, images, digital stickers, audio and video.

Implementations may include functionality associated with Sending or transmitting information and/or Receiving information. The present invention provides a Parent with control capable of blocking any content transmitted to, or transmitted from a minor associated with the parent.

Either Parent and/or either Child may enforce a no-send command or no receive command. History is maintained and future rules can be enforced (i.e., no longer allow messages from or to a particular sender).

Messages modalities supported may include one or more of: text strings, Video files; Image files, including those generated from digital finger paint; digital Stickers, Emoticons; or other digital transmission types.

Functionality may include Parent/Guardian Options to provide one or more of: Block All (Send/Receive/Both); Block Specific Message; Block Specific User(s) (Blacklist); Allow or “allow only” Specific User(s) (Whitelist); Create Alert for potentially abusive sender; Report Abuse (to one or more of: a website administrator; a proctor and another Parent); Allow All to pass through.

Functionality related to a History may include one or more of: all history is all or partially saved to a storage or time constraint, including action taken by a parent/guardian and one or more proctored children; action taken by a parent/guardian and one or more children that are not proctored by the history storing Parent; and Offensive message content can be removed from history.

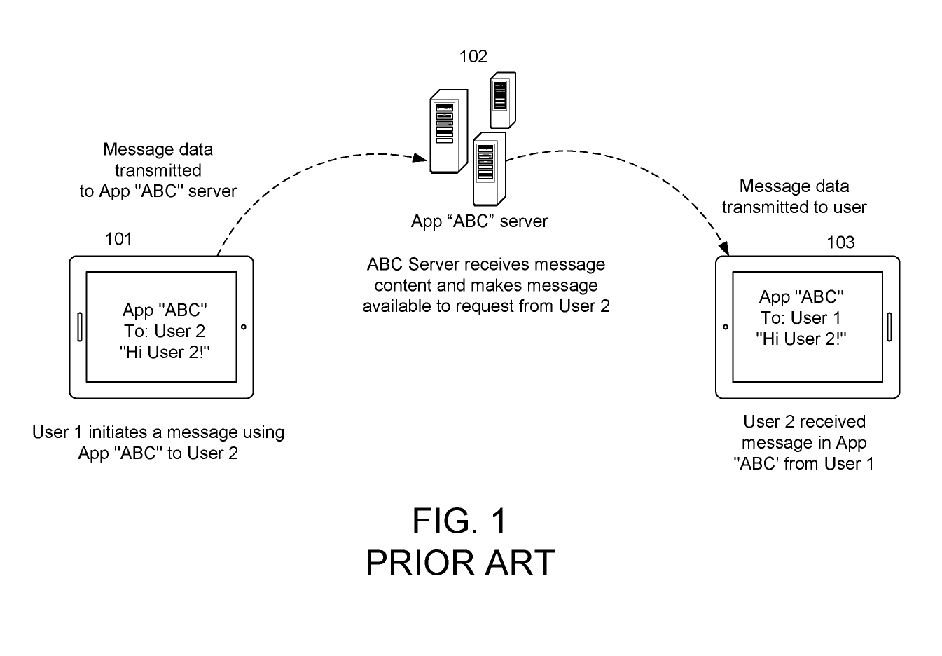

Referring now to FIG. 1, in previous methodologies, a User 1 operates a first User device 101 to initiate a message to a second User device 103, using an application App 101. A web based server 102 running executable software receives the message content and makes the message content available to the second user device 103. There are no controls on content that may be overseen by a parent or guardian.

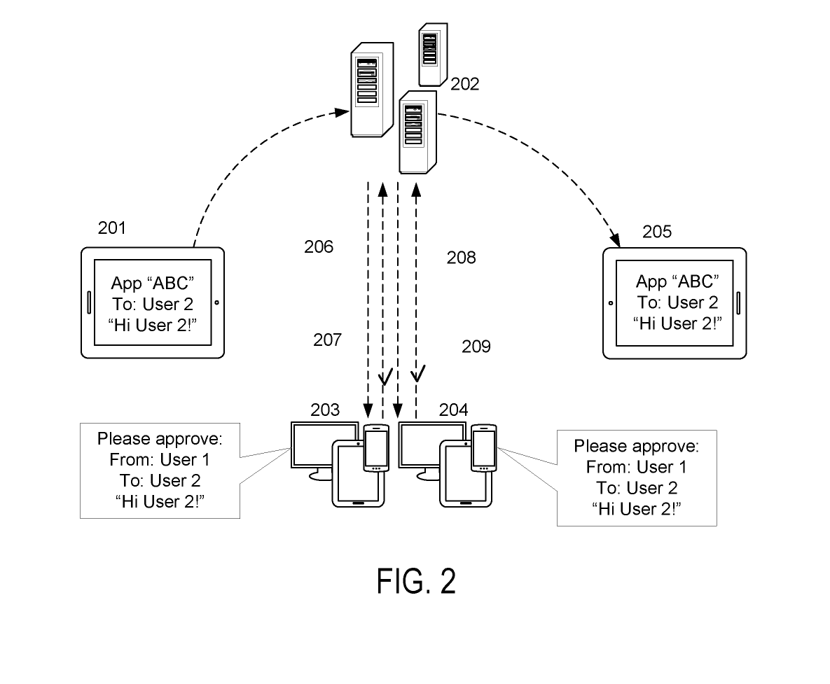

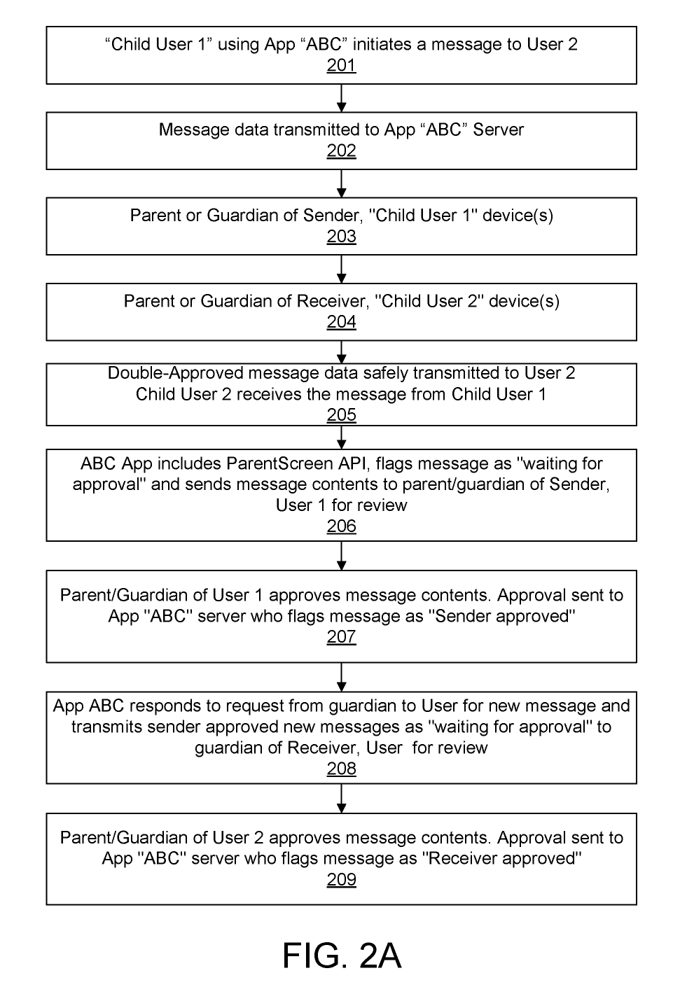

Referring now to FIG. 2, a block diagram illustrates method steps that may be implemented in some embodiments of the present invention. As illustrated, a first user 201 (generally a Child or a Minor), registered as a child or a minor initiates a message to a second user 205. The message is transmitted to an app server 202. The app server 202 invokes a parent screen API and flags the message as waiting for approval. The app server also sends the message content to a parent/guardian 203 for the first user 201. The parent/guardian for the first user approves the message content and the content is forwarded by the app server 202 to the parent for the second user 204. The parent for the second user 204 approves the message and the double approved message is transmitted to the second user 205.

In addition to message content, the app server 202 may also transmit to a parent/guardian other data associated with a transmitted message. Data associated with a message may include one or more of: where the message originated as determined via a GPS apparatus included in a first user device used to initiate the message, a location where the second user 205 is located as determined via a GPS apparatus in a second user device a time of message origination, a type of message (such as video, image or text) and which, if any other users are included to receive the message (a group message).

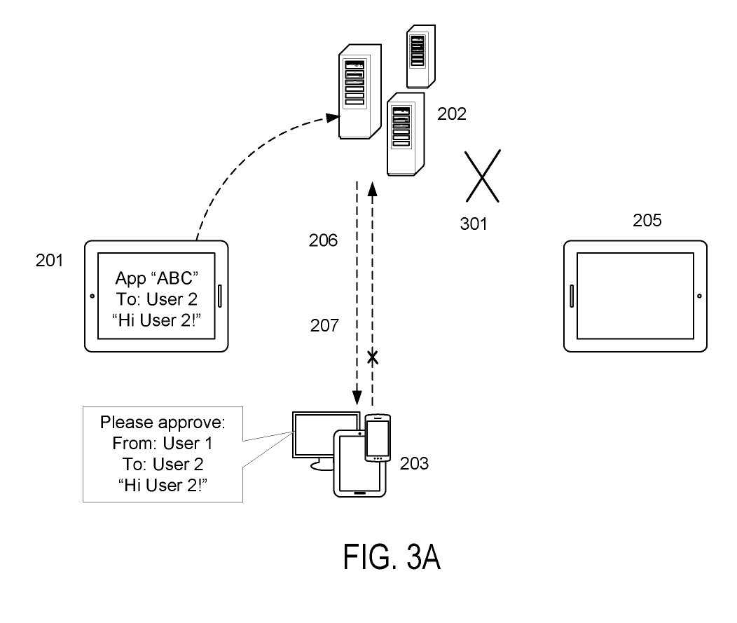

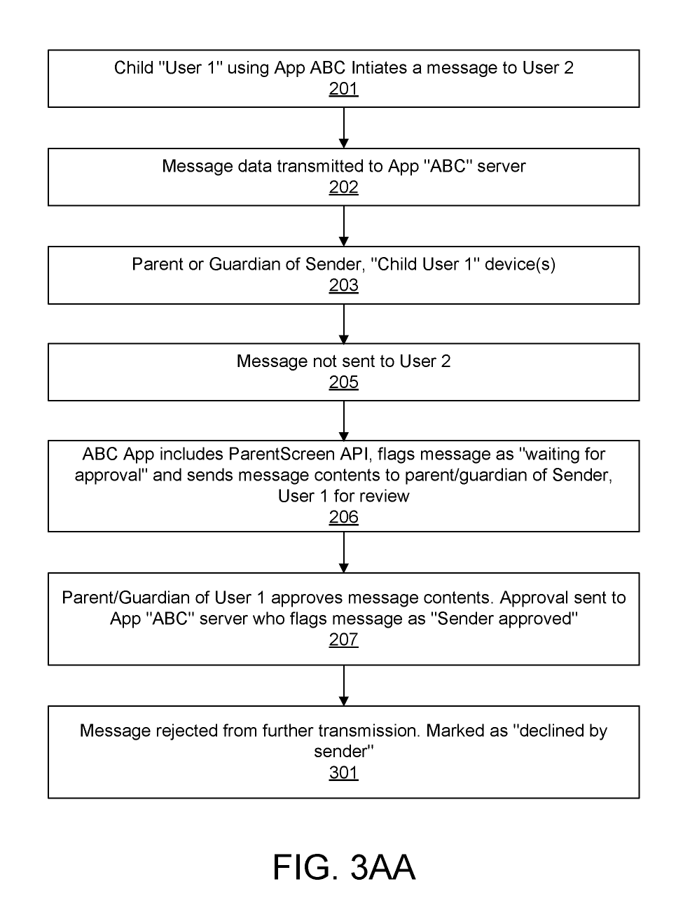

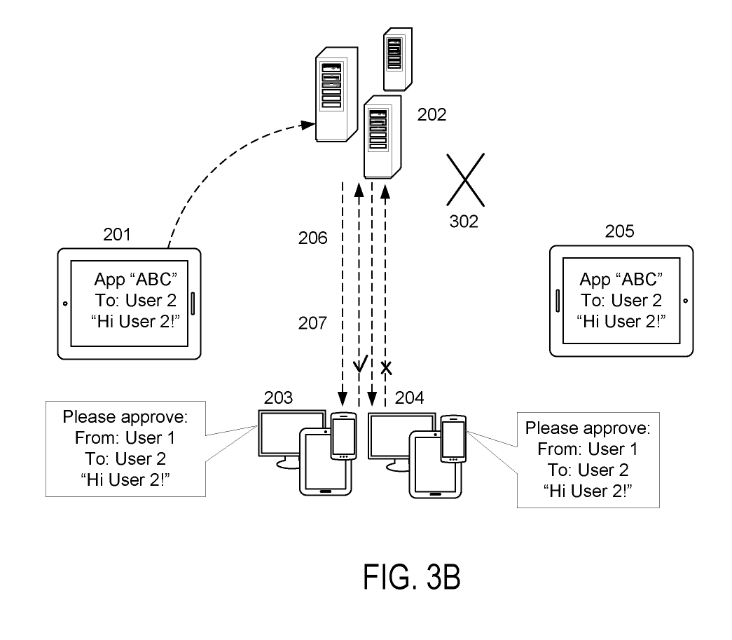

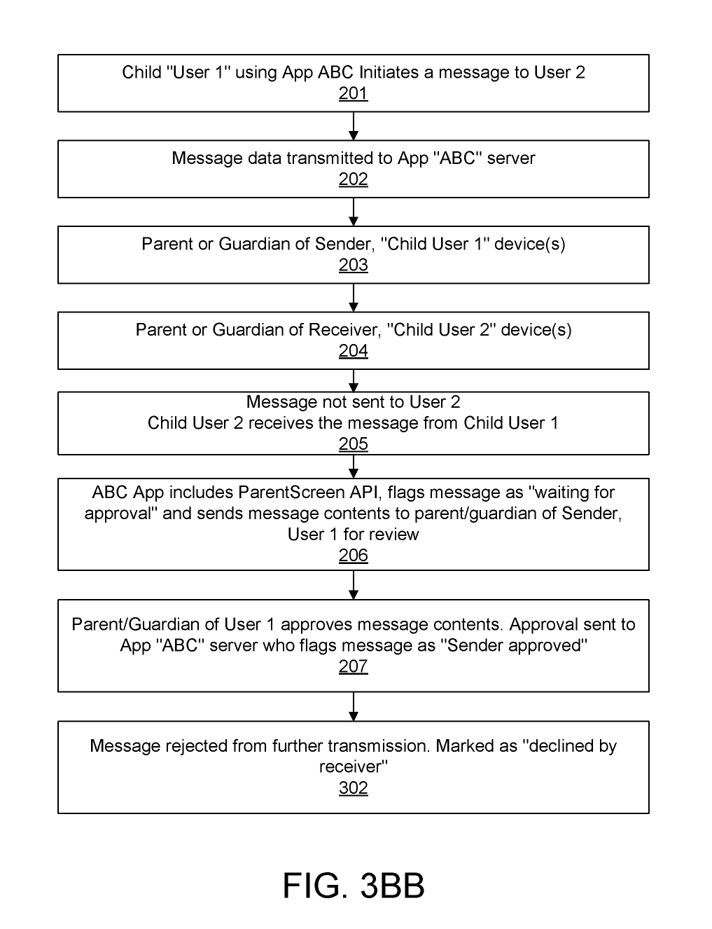

Referring now to FIG. 3A, a process similar to the process illustrates in FIG. 2 transpires: a first user 201 (generally a Child or a Minor), registered as a child or a minor initiates a message to a second user 205. The message is transmitted to an app server 202. The app server 202 invokes a parent screen API and flags the message as waiting for approval. The app server also sends the message content to a parent/guardian 203 for the first user 201. However, in FIG. 3A at 301, parent/guardian 203 for the first user 201 denies the sending of the message to the second user 205 and the message is not transmitted to the second user 205.

Referring now to FIG. 3B, a process similar to the process illustrates in FIG. 3A transpires: a first user 201 (generally a Child or a Minor), registered as a child or a minor initiates a message to a second user 205. The message is transmitted to an app server 202. The app server 202 invokes a parent screen API and flags the message as waiting for approval. However, in FIG. 3B the app server sends the message content to a parent/guardian 203 for the first user 201, receives approval from the parent for the first user 203 and transmits the message to the parent for the second user 204 at 302, parent/guardian for the second user 204, denies the sending of the message to the second user 205 and the message is not transmitted to the second user 205.

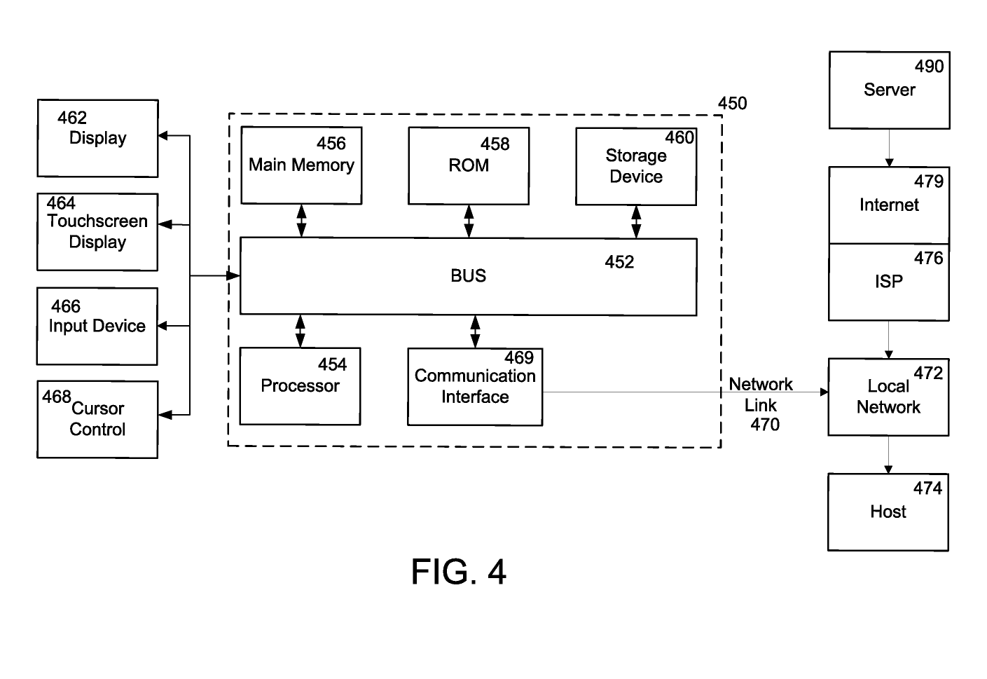

Referring now to FIG. 4, additional aspects of controller hardware useful for implementing the present invention are illustrated as a block diagram that includes a controller 450 upon which an embodiment of the invention may be implemented. Controller 450 includes a bus 452 or other communication mechanism for communicating information, a database to track message status, and a processor 454 coupled with bus 452 for processing information.

Controller 450 also includes a main memory 456, such as a random access memory (RAM) or other dynamic storage device, coupled to bus 452 for storing information and instructions to be executed by processor 454. Main memory 456 may also be used for storing temporary variables, data records or other intermediate information during execution of instructions to be executed by processor 454. Main memory 456 may also store a log of messages sent from a first user 201 to a second user 205 and actions, such as approvals or denials taken by parents/guardians regarding messages sent. Controller 450 further includes a read only memory (ROM) 458 or other static storage device 460.

Controller 450 may be coupled via bus 452 to a display 462, such as a cathode ray tube (CRT), liquid crystal display (LCD), plasma display panel (PDP), organic light-emitting diode (OLED), projector, or heads up display for displaying information to a computer user. An input device 466, including alphanumeric and other keys, may be coupled to bus 452 for communicating information and command selections to processor 454. Another type of user input device is cursor control 468, such as a mouse, a trackball, a touchpad, or cursor direction keys for communicating direction information and command selections to processor 454 and for controlling cursor movement on display 462. Another type of user input device is a touchscreen display 464 where a user may communicate information and command selections to processor 454 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane. Other implementations may include a 3D touch or other device to register “gestures” and “multiple touch points (i.e., two finger swipe).

Embodiments of the invention are related to the use of controller 450 for setting operational parameters relating to digital messaging and game playing. According to some embodiment of the invention, ParentScreen parameters are defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry, input methods and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460 and 458. Volatile media includes dynamic memory, such as main memory 456. Transmission media includes coaxial cables, copper wire and fiber optics, including the wires that comprise bus 452. Transmission media may also take the form of acoustic or light waves, such as those generated during radio wave and infrared data communications (i.e. WiFi and 4G LTE, Bluetooth and other wireless digital communication protocols).

Common forms of computer-readable media include, for example, a memory stick, hard disk or any other magnetic medium, a Solid State Disk (SSD), a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 454 for execution. For example, the instructions may initially be carried on a magnetic or solid state disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Controller 450 also includes a communication interface 469 coupled to bus 452. Communication interface 469 provides a two-way data communication coupling to a network link 470 that may be connected to a local network 472. For example, communication interface 469 may operate according to the internet protocol. As another example, communication interface 469 may be a local area network (LAN) card allowing a data communication connection to a compatible LAN. Wireless links may also be implemented.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic or optical signals that carry digital data streams. The signals through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. In this manner, controller 450 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad and tablet devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic or solid state disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the user device. These selections will be set according to per se well-known conventions in the software and mobile device community.

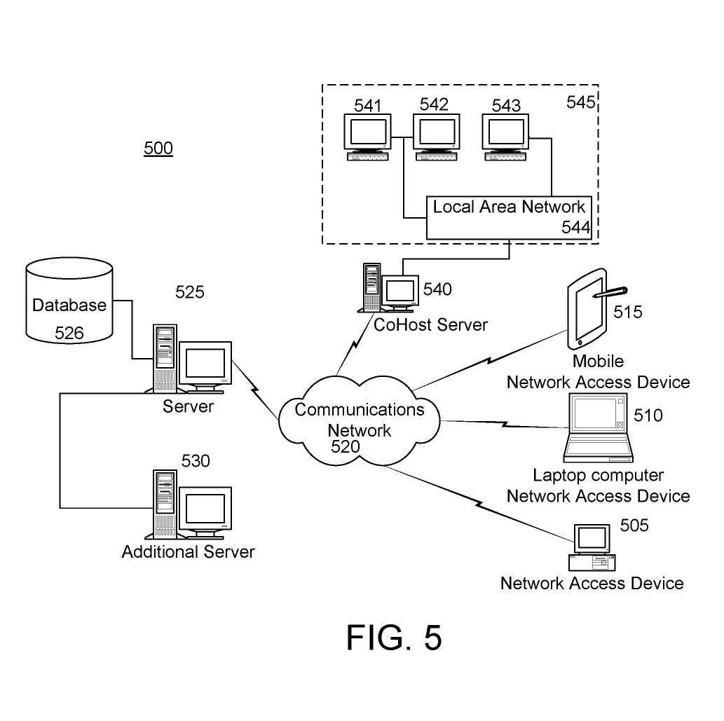

Referring now to FIG. 5, an exemplary processing and interface system 500 is illustrated. In some aspects, access devices 515, 510, 505, such as a mobile device 515 or laptop computer 510 may be able to communicate with an external server 525 though a communications network 520. The external server 525 may be in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such a social network, such as Facebook™ or a game or dating website.

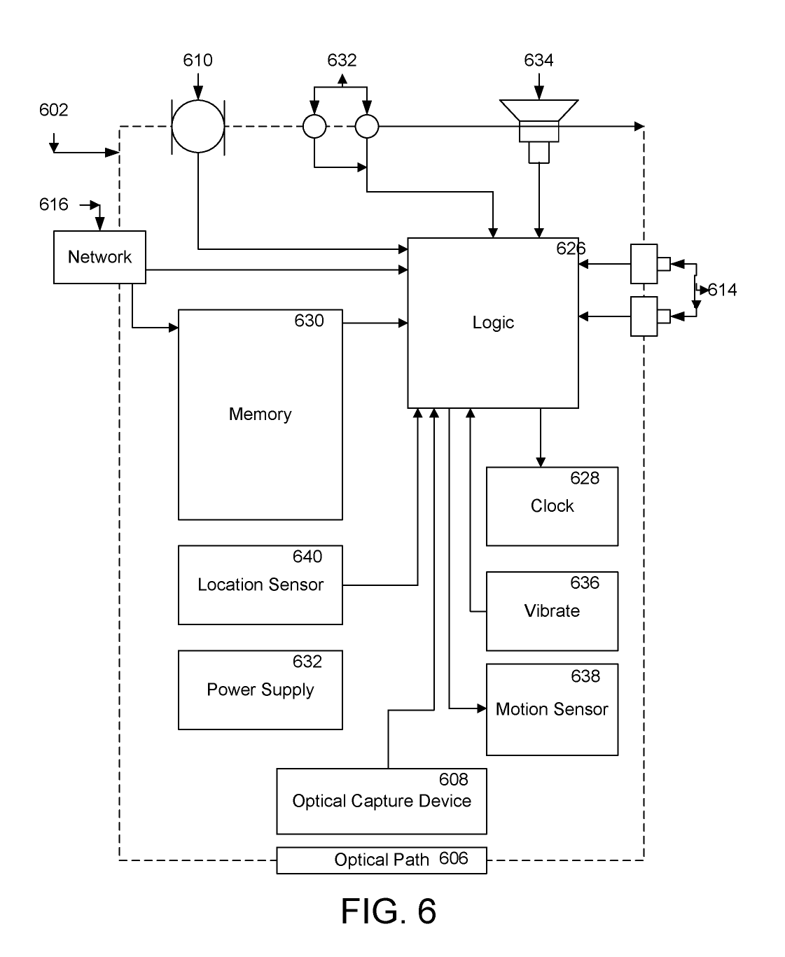

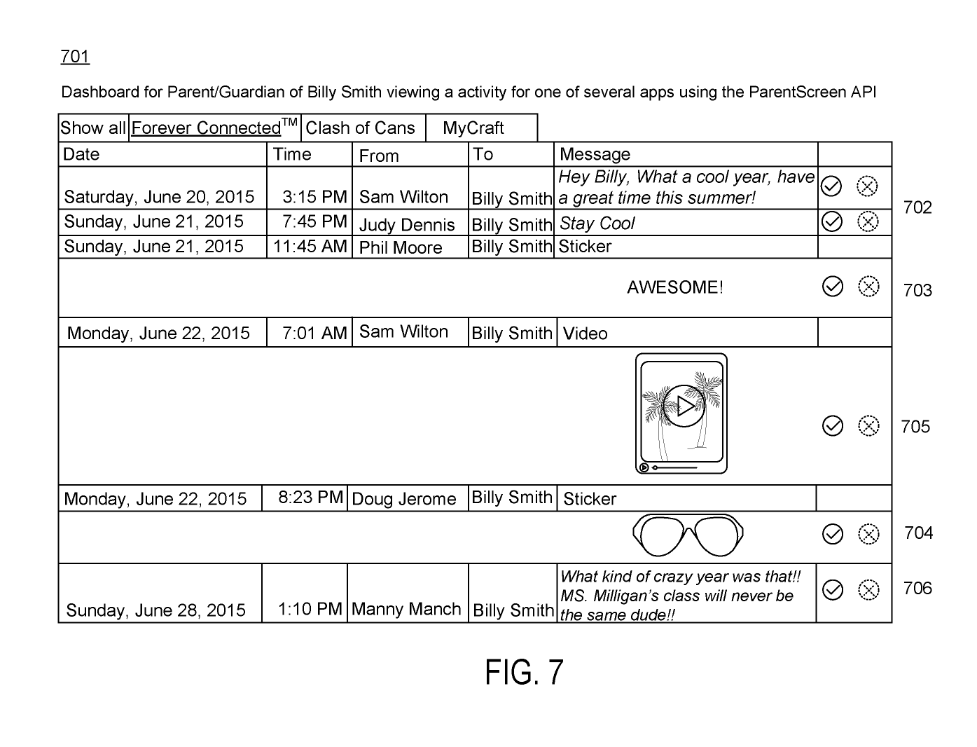

Referring now to FIG. 6, a block diagram of an exemplary embodiment of a mobile device 602 is illustrated. The mobile device 602 may comprise an optical capture device 608, the optical capture device 608 may incorporate a Charge-Coupled Device (CCD), a Complementary Metal Oxide Semiconductor (CMOS) imaging device, or an optical sensor of another type.

In some embodiments, the mobile device 602 may comprise a microphone 610, wherein the microphone 610 and associated circuitry may convert the sound of the environment, including spoken words, into machine-compatible signals. Input facilities 614 may exist in the form of buttons, scroll-wheels, or other tactile sensors such as touch-pads. In some embodiments, input facilities 614 may include a touchscreen display. Visual feedback 632 to the user may occur through a visual display, touchscreen display, or indicator lights. Audible feedback 634 may be transmitted through a loudspeaker or other audio transducer. Tactile feedback may be provided through a vibration module 636.

In some aspects, the mobile device 602 may comprise a motion sensor 638, wherein the motion sensor 638 and associated circuitry may convert the motion of the mobile device 602 into machine-compatible signals. For example, the motion sensor 638 may comprise an accelerometer, which may be used to sense measurable physical acceleration, orientation, vibration, and other movements. In some embodiments, the motion sensor 638 may comprise a gyroscope or other device to sense different motions.

In some implementations, the mobile device 602 may comprise a location sensor 640, wherein the location sensor 640 and associated circuitry may be used to determine the location of the device. The location sensor 640 may detect Global Position System (GPS) radio signals from satellites or may also use assisted GPS where the mobile device may use a cellular network to decrease the time necessary to determine location. In some embodiments, the location sensor 640 may use radio waves to determine the distance from known radio sources such as cellular towers to determine the location of the mobile device 602. In some embodiments these radio signals may be used in addition to and/or in conjunction with GPS.

In some aspects, the mobile device 602 may comprise a logic module 626, which may place the components of the mobile device 602 into electrical and logical communication. The electrical and logical communication may allow the components to interact. Accordingly, in some embodiments, the received signals from the components may be processed into different formats and/or interpretations to allow for the logical communication. The logic module 626 may be operable to read and write data and program instructions stored in associated storage 630, such as RAM, ROM, flash, or other suitable memory. In some aspects, the logic module 626 may read a time signal from the clock unit 628. In some embodiments, the mobile device 602 may comprise an on-board power supply 632. In some embodiments, the mobile device 602 may be powered from a tethered connection to another device, such as a Universal Serial Bus (USB) connection.

In some implementations, the mobile device 602 may comprise a network interface 616, which may allow the mobile device 602 to communicate and/or receive data to a network and/or an associated computing device. The network interface 616 may provide two-way data communication. For example, the network interface 616 may operate according to an internet protocol. As another example, the network interface 616 may comprise a local area network (LAN) card, which may allow a data communication connection to a compatible LAN. As another example, the network interface 616 may comprise a cellular antenna and associated circuitry, which may allow the mobile device to communicate over standard wireless data communication networks. In some implementations, the network interface 616 may comprise a Universal Serial Bus (USB) to supply power or transmit data. In some embodiments, other wireless links known to those skilled in the art may also be implemented.

As an illustrative example of a mobile device 602, a reader may scan some text from a newspaper article with mobile device 602. The text is scanned as a bit-mapped image via the optical capture device 608. Logic 626 causes the bit-mapped image to be stored in memory 630 with an associated time-stamp read from the clock unit 628. Logic 626 may also perform optical character recognition (OCR) or other post-scan processing on the bit-mapped image to convert it to text. Logic 626 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 626) to an associated computer via network interface 616.

As an example of another use of mobile device 602, a reader may capture some text from an article as an audio file by using microphone 610 as an acoustic capture port. Logic 626 causes audio file to be stored in memory 628. Logic 626 may also perform voice recognition or other post-scan processing on the audio file to convert it to text. As above, the reader may then upload the audio file (or text produced by post-scan processing performed by logic 626) to an associated computer via network interface 616.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. Automated apparatus for facilitating control over content accessed by a minor using a digital communication device, the apparatus comprising:
a computer server in logical communication with a digital communications network and configured to be accessed by a network access device via the digital communications network; and
executable software stored on the computer server and executable on demand, the software operative with the computer server to cause the computer server to:
receive ParentScreen data certifying an adult as a Parent of an associated Child;
receive a digital transmission via the communication network addressed to the Child;
transmit the digital transmission addressed to the Child to the Parent;
receive an instruction from the Parent, said instruction comprising one of:
authorize the transmission to the Child and block the transmission to the Child; and
execute the received instruction.

2. The apparatus of claim 1 wherein the server is additionally operative to log a history of communications to the Child.

3. The apparatus of claim 1 wherein the server is additionally operative to log a history of instructions received from the Parent and relating to the Child.

4. The apparatus of claim 1 wherein the server is additionally operative to calculate a volume of messages sent to the Child.

5. The apparatus of claim 1 wherein the server is additionally operative to calculate a volume of messages sent to the Child from a particular Sender.

6. The apparatus of claim 1 wherein the server is additionally operative to calculate a volume of messages sent to the Child from a particular Sender during a designated time period.

7. The apparatus of claim 1 wherein the server is additionally operative to calculate a volume of messages sent to the Child from a particular Sender that has been blocked by the Parent.
